(19) United States
(12) Patent Application Publication
(10) Pub. No.: US 2009/0313176 A1
(43) Pub. Date: Dec. 17, 2009

(54) FUND TRANSACTION PLATFORM AND METHOD OF AUTONOMOUS INTEREST RATES OF CAPITAL POOL

(76) Inventor: Yung-Sung Chien, Taipei (TW)

Correspondence Address: SINORICA, LLC, 2275 Research Blvd., Suite 500, ROCKVILLE, MD, 20850, US

(21) Appl. No.: 12/254,116

(22) Filed: Oct. 20, 2008

(30) Foreign Application Priority Data
Jun. 15, 2008 (TW) 97120921

(51) Int. Cl. G06Q 40/00

(52) U.S. Cl. 705/36 R; 705/37

(57) ABSTRACT

A fund transaction method of autonomous interest rates of a capital pool is applied in a fund transaction platform. A clearing member applies to join the fund transaction platform. A fund flow and an information flow are established between the fund transaction platform and the clearing member. A customer of the clearing member registers with the fund transaction platform to become a member. The member enters a bidding amount. A successful bidding amount and a number of successful bidders are determined according to a fund balance of the fund transaction platform and borrowing interest rates. A management server clears a successful bidding amount and a deposit bid bond. The fund transaction platform performs a clearance and settlement for the clearing member. The clearing member clears and settles the successful bidding amount, the total successful bidding amount, the deposit amount, or the refunding amount for the customer.

### BACKGROUND OF THE INVENTION

1. Field of Invention

The present invention relates to an electronic commerce (e-commerce) fund transaction platform and method, and more particularly to a fund transaction platform and method of autonomous interest rates of a capital pool.

2. Related Art

In the conventional financial deposit and borrowing system, a non-specific person deposits money in the bank. The bank pays the deposit interest and lends the money to another non-specific person at a higher loan interest, so as to gain the interest margin. This deposit and borrowing system is known as indirect finance. In the indirect finance times, both the depositor and the borrower are influenced by closed information, and the bankers have the relative advantage in terms of information. Therefore, in financial historians' opinion, the bank makes profit on information asymmetry in the times of indirect finance.

Conventionally, direct finance in the form of civil bidding Rotating Savings and Credit Association (ROSCA) is another form of deposit and borrowing, which meets the needs of small loans. However, the action of “bidding” is difficult to fully meet the borrower's demand for funds, and the group of “association” is a great wall between the borrower and the depositor and cannot fully reflect the demands of both parties.

With the rapid development of network technology, any tangible objects and services in physical forms are gradually e-commercialized in a virtual sense, and money similar to the information form is no exception. At the early stage, some bankers of insight introduce computer information systems to turn conventional financial services into e-services, so as to make the conventional financial services convenient, fast, and reliable, and to reduce the manpower and material resources greatly.

However, forward-looking financial enterprises and experts are not satisfied with this. In their opinion, the e-bank now is a closed system of the bank and customers, which has not yet reflected the transaction forms that should be exhibited by the direct finance when the information symmetry of both parties of the transaction is achieved in the era of network technology.

Therefore, the bankers all over the world are making efforts to seek an answer to the question. Above all, it must create an immediate contact between the depositor and the borrower. Moreover, it must provide customers with chances to determine their borrowing/saving interest rates, that is, provide their real customized financial products.

The British ZOPA company (ZOPA, www.zopa.com) created an online financial deposit and borrowing platform with separated risks for the depositor and the borrower in 2005. This deposit and borrowing platform is similar to the direct finance, but involves too many human operations and is limited to the micro-finance. In 2006, US Prosper (www.prosper.com) company in California used a community concept to operate the deposit and borrowing of funds. Furthermore, for example, U.S. Patent Application Publication No. 2006/0224502A1 disclosed a “System and method for online peer-to-peer banking”. Basically, all the above are reinforcements to conventional financial business instead of optimal deposit and borrowing mechanisms in the era of network technology.

In view of this, the article “Construction of Direct Financial Deposit and Borrowing Method by Using Network Bidding ROSCA” by Kuen-Bao Ling et al. on Mar. 7, 2008 discloses a direct financial deposit and borrowing method, which includes creating a deposit and borrowing mechanism with a conventional bidding ROSCA to make the depositor meet the borrower directly without any intermediary, so as to avoid the human control of the interest margin. The article also introduces a concept of general fund balance. The conventional mutual aid association has many limitations in operation due to the restrictions on number of members, amount, and time. Associations of various forms and users of various conditions are combined together, and a result of bids is determined according to the total fund balances of all periods of bids to obtain successful bidders, respective successful bidding amount of the successful bidders, as well as bid bonds and amount that unsuccessful bidders should deposit. This concept not only breaks all limitations of the mutual aid association, but also enables later operators of this mechanism to reduce the load of the network bidding ROSCA system. The article further reflects the market interest rate. Due to the direct finance, the depositor and the borrower can gain the most appropriate interest rate from each other. Therefore, the deposit and borrowing interest rates obtained via this mechanism can reflect the most proper interest rate condition of the market. Moreover, since this mechanism combines bidding ROSCAs of various forms, the probability that unreasonable bid bonds influence the bidding condition of the market is prevented, so the deposit and borrowing interest rates are more representative.

However, the existing online direct financial transaction mode either cannot create an opportunity for real contact between the depositor and the borrower, or it has too many human operations that influence the fund allocation efficiency, or is limited to the closed form of limited participants and cannot realize a large and open free market of funds. Or, financial institutions respectively develop different direct financial service patterns and information platforms, so that the common value of the network direct finance cannot be achieved.

Furthermore, due to the barrier between financial counterparts that focus only on conducting their own business, a detached and equal, fair, and open direct financial fund transaction platform that enables different financial institutions to carry out the work of credit checking, credit control, payment, and the like on the basis that their customers are respectively retained cannot be established. Next, the scope of the direct financial fund transaction platform cannot be enlarged, so the closeness between the financial counterparts cannot be broken, and human operations cannot be reduced. Therefore, the operation efficiency of activities of the direct financial fund transaction platform is not improved. Moreover, the optimal allocation of the investment and savings cannot be achieved and the risks between them cannot be reduced, that is to say, the social resources cannot be utilized most effectively.

### SUMMARY OF THE INVENTION

In order to solve the above problems, the present invention is directed to an online direct finance operating system of a concept of online capital pool in the banking or related financial industries, which facilitates an integral face-to-face contact between a depositor and a borrower, and on the other hand makes an interest rate float and reflect individual demands through an equal, open, and fair bidding method by using fast and reliable network technology, so as to achieve an optimal allocation of market funds. A participating bank or related financial institution carries out the work of credit checking, credit control, guarantee, payment, and the like without losing any customer, which changes the conventional operating methods of indirect finance and achieves the reasonable operating mode of direct finance in the Internet era. The present invention has the following inventive steps and practicabilities compared with the conventional indirect financial lending and financing methods:

1. A fund transaction platform of an online capital pool is established through the Internet and the credit information collection, credit control, guarantee, and payment services of existing banks or finance-related institutions are linked by means of bidding, so as to enable members of different attributes such as lending or arbitrage to participate in fund bidding combinations across banks and finance-related institutions and create great opportunities for lenders and borrowers to meet rapidly and effectively.

2. A capital bidding platform across banks and peripheral financial institutions is established to form a capital pool. The lender can lend the money without risks under the guarantee of the financial institutions. The borrower also guarantees a fulfillment of the debt under the guarantee of the banks. The banks can reduce the deposit liabilities, and can gain the commission charge for lending by retaining customer loyalty without spending a lot of money establishing a fund transaction platform, thereby fully exploiting the benefit of the economy of scale.

3. A totally open and competitive online fund transaction platform is established, so that the interest rate reflects the intensity of demand for funds in the market in real time due to the competitive bidding, and the deposit and borrowing come into an optimal state of direct finance without distance and without any intermediary due to the integration.

4. A capital pool of a financial system is constructed, which is open to participation of various banks and peripheral financial institutions, and the flow of savings fund is efficiently directed towards the productive purpose (i.e., the investment) by means of competitive bidding.

The present invention provides a fund transaction method of autonomous interest rates of a capital pool applied in a fund transaction platform. The fund transaction platform includes a management server and a database. The fund transaction method of autonomous interest rates of the capital pool includes the following steps. First, a clearing member applies to join the fund transaction platform. Then, a fund flow is established between the fund transaction platform and the clearing member, and an information flow is established between the fund transaction platform and a financial transaction system of the clearing member. Next, a customer of the clearing member registers with the fund transaction platform through a member terminal to become a member. Furthermore, the member enters a bidding amount into the fund transaction platform from the member terminal. The management server calculates an average deposit interest rate and a borrowing interest rate of the bidding member according to the entered bidding amount, and determines a successful bidding amount and a number of successful bidders according to a fund balance of the fund transaction platform and the borrowing interest rates of the bidding member. Afterwards, the management server clears a total successful bidding amount of a successful bidding member according to the successful bidding amount, and clears a deposit amount of an unsuccessful bidding member according to the average borrowing interest rate and a deposit bid bond of the successful bidding member, a highest bidding amount of the unsuccessful bidding member, or a benchmark interest rate. Then, the fund transaction platform transfers the cleared successful bidding amount, total successful bidding amount, deposit amount, and/or refunding amount of the customer of the clearing member to the financial transaction system of the clearing member through the information flow. Next, the fund transaction platform settles the successful bidding amount, the total successful bidding amount, the deposit amount, and/or the refunding amount of the customer of the clearing member by the fund flow. Also, the clearing member clears and settles the successful bidding amount, the total successful bidding amount, the deposit amount, or the refunding amount for the customer.

The present invention provides a fund transaction platform of autonomous interest rates of a capital pool, which includes:

a management server, for entering a bidding amount to calculate an average deposit interest rate and a borrowing interest rate, determining a successful bidding amount and a number of successful bidders according to a fund balance of the fund transaction platform and the borrowing interest rates, clearing a total successful bidding amount according to the successful bidding amount, and clearing a deposit amount according to the average borrowing interest rate and a deposit bid bond, a highest bidding amount, or a benchmark interest rate; and

a database, with which the management server accesses data about the clearing member, the member, the average deposit interest rate, the borrowing interest rate, the fund balance, the successful bidding amount, the number of successful bidders, the total successful bidding amount, the deposit bid bond, the average borrowing interest rate, and the deposit amount.

A fund flow is established between the fund transaction platform and a clearing member, and an information flow is established between the fund transaction platform and a financial transaction system of the clearing member. The fund transaction platform transfers the cleared successful bidding amount, total successful bidding amount, deposit amount, and/or refunding amount to the financial transaction system through the information flow. The fund transaction platform settles the successful bidding amount, the total successful bidding amount, the deposit amount, and/or the refunding amount of the clearing member through the fund flow.

### BRIEF DESCRIPTION OF THE DRAWINGS

The present invention will become more fully understood from the detailed description given herein below for illustration only, and thus are not limitative of the present invention, and wherein:

FIG. 1 is a block diagram of a fund transaction platform of autonomous interest rates of a capital pool of the present invention;

FIG. 2 is a flow chart of a fund transaction method of autonomous interest rates of a capital pool of the present invention;

FIG. 3 is a flow chart showing how a clearing member joins in a fund transaction platform in the fund transaction method of autonomous interest rates of the capital pool of the present invention; and

FIG. 4 is a flow chart showing how a pure arbitrager or saver joins in the fund transaction platform in the fund transaction method of autonomous interest rates of the capital pool of the present invention.

### DETAILED DESCRIPTION OF THE INVENTION

Before describing preferred embodiments of the present invention, the characteristics of deposit and borrowing at autonomous interest rates of the present invention are described first, and these characteristics are applied in the following embodiments.

A deposit and borrowing method of autonomous interest rates with the characteristic of direct finance is mainly constructed on a concept of fund balance. A management server of a financial transaction platform calculates corresponding borrowing interest rates according to bid bonds of all bidders and determines the number of people who win the bid, the total successful bidding amount that all successful bidders can obtain, and the amount that unsuccessful bidders (depositors here) should deposit at each time point (i.e., a bid opening time) according to the fund balance and the borrowing interest rates. The process is as follows:

In a first step, let the number of successful bidders be zero, and the management server of the financial transaction platform calculates a fund balance at this time point. The financial transaction platform calculates the fund balance by subtracting the total successful bidding amount of all successful bidders at this time point from the amount that all unsuccessful bidders (herein the depositors) should deposit at this time point. Only a total deposit amount of all depositors needs to be calculated in this step. The amount required to be deposited by the unsuccessful bidder (the depositor here) is calculated based on the following two formulas according to the order of interest payment:

Early interest payment:

U−IXₙ (1)

Late interest payment:

U (2)

where,

U is a competitive bidding upper limit of the bidder; and

IXₙ is a deposit bid bond of the depositor calculated according to a benchmark interest rate of the n^{th} period.

In addition, the total successful bidding amount of the successful bidders (the borrowers) is calculated based on the following two formulas according to the order of interest payment:

Early interest payment:

Aₙ=(U−Iₙ)×(N−n)+U×(n−1) (3)

Late interest payment:

$${A}_{n} = U \times ( N - n ) + U \times ( n - 1 ) + {\sum }_{i = 1}^{n - 1} {I}_{i} \qquad ( 4 )$$

where,

Aₙ is the total successful bidding amount of the successful bidders when the bid is won in the n^{th} period;

U is a competitive bidding upper limit;

N is total contracted periods;

n is a current period, and n≦N;

Iₙ is the successful bidding amount in the n^{th} period of the successful bidder; and

Iᵢ is the amount that the depositor deposits in the i^{th} period, and i<n.

The early interest payment refers to that the interest to be paid in the future has been deducted from the obtained principal in advance at borrowing, which is similar to the zero coupon bond. The late interest payment refers to that complete principal can be obtained at borrowing and the interest is paid at refunding in the future, which is similar to the common loan or house loan.

In a second step, the management server of the fund transaction platform determines whether a fund balance X at a previous time point+a fund balance B₀ at this time point (i.e., a fund level) is less than or equal to zero. If the fund balance X at the previous time point plus the fund balance B₀ at this time point is less than or equal to zero (i.e., B₀+X≦0), the fund transaction platform determines that nobody wins the bid at this time point, that is, all bidders have to deposit money at this time point. On the contrary, if the fund transaction platform determines that the fund balance is greater than zero, the flow proceeds to a third step.

When a deposit and borrowing mechanism of autonomous interest rates similar to the direct finance is constructed, the fund balance in the fund transaction platform should be zero. However, the probability that the fund balance in the fund transaction platform is exactly equal to zero is very small. Therefore, the fund balance thereof is bound to be greater than or equal to or smaller than or equal to zero. If the fund balance in the fund transaction platform is greater than zero, for a financial institution operating this method, the form of the fund balance becomes a borrowing amount of the financial institution, resulting in an outlay cost of the financial institution. If the fund balance in the fund transaction platform is smaller than zero, for the financial institution operating this method, the form of the fund balance becomes a lending amount of the financial institution, and the financial institution can gain a small amount of commission charge, thereby changing the conventional operating mode of indirect finance that the financial institution gains a margin between the deposit interest rate and the loan interest rate. Here, in the deposit and borrowing method of autonomous interest rates, it is assumed that the fund balance in the fund transaction platform is smaller than or equal to zero in the operation of the competitive bidding transaction.

In the third step, the borrowing interest rates are sorted. If the fund balance calculated by the management server of the fund transaction platform in the second step is greater than zero, the fund transaction platform calculates corresponding borrowing interest rates for the bidding amounts of bidders who submit bids, and sorts the borrowing interest rates. When a borrowing interest rate of bid bond in the n^{th} (n falls at this time point for calculation) period of a bidder is calculated, the management server of the fund transaction platform first uses the following formula (5) to calculate an average deposit interest rate r of previous periods of the bidder, and then uses the following formula (6) to calculate a borrowing interest rate R if the bid is won at the time point, for example, by using a financial concept of internal rate of return (IRR). The formulas are as follows:

$$\begin{matrix}{\sum }_{i = 1}^{n - 1} ( U - {I}_{i} ) \times {( I + r )}^{N - i} = U \times ( n - 1 ) & ( 5 ) \\ {\sum }_{i = 1}^{n - 1} ( U - {I}_{i} ) \times {( I - r )}^{n - i} + {\sum }_{j = 1}^{N - n} U \times {( \frac{1}{I + R} )}^{j} = {A}_{n} & ( 6 )\end{matrix}$$

where,

U is a bidding upper limit;

N is a total contracted periods;

n is a current period, and n≦N;

Iᵢ is the amount that the depositor deposits in the i^{th} period, and i<n;

r is the average deposit interest rate from the 1^{st} to the i^{th} period of the depositor;

R is the borrowing interest rate; and

Aₙ is the total successful bidding amount of the successful bidders if the bid is won in the n^{th} period, and is calculated with reference to formulas (3) and (4).

The management server of the fund transaction platform sorts the borrowing interest rates from high to low corresponding to all bidders immediately after calculating the borrowing interest rates of all bidders at this time point.

In a fourth step, the management server of the fund transaction platform finds a maximum number of successful bidders making the fund balance smaller than or equal to zero.

In this step, for example, a concept of trial and error method is used to find the number of the successful bidders n when the fund balance at this time point plus the fund balance at a previous time point of the management server of the fund transaction platform is smaller than or equal to zero, and then, a minimum number of bidders who win the bid is found:

Min [symbol] n|Bₙ+X<=0 [symbol] (7)

where,

Bₙ is the fund balance when the number of the successful bidders at this time point is n; and

X is the fund balance at the previous time point.

In a fifth step, the successful bidders are cleared. For the successful bidders (borrowers), the management server of the fund transaction platform calculates the total successful bidding amount of the successful bidders in the situation that the bid is won at this time point. The calculation of the fund transaction platform is based on the following two formulas according to the order of interest payment:

Early interest payment:

Aₙ=(U−Iₙ)×(N−n)+U×(n−1) (8)

Late interest payment:

$${A}_{n} = U \times ( N - n ) + U \times ( n - 1 ) + {\sum }_{i = 1}^{n - 1} {I}_{i} \qquad ( 9 )$$

where,

Aₙ is the total successful bidding amount of the successful bidders when the bid is won in the n^{th} period;

U is a bidding upper limit;

N is total contracted periods;

n is a current period, and n≦N;

Iₙ is the successful bidding amount in the n^{th} period of the successful bidder; and

Iᵢ is the amount that the depositor deposits in the i^{th} period, and i<n.

The bidder needs to refund in the future periods, and a refunding amount is calculated according to the following formulas:

Early interest payment:

U (10)

Late interest payment:

U+Iₙ (11)

where,

U is a bidding upper limit; and

Iₙ is the amount that the bidder bids in the n^{th} period.

In a sixth step, the users who do not win the bid are cleared. When the management server of the fund transaction platform determines that the number of people that may win the bid at this time point is n (n=1 . . . N), the management server of the fund transaction platform calculates an average borrowing interest rate when the number of bidders who win the bid at this time point is n, and then calculates a deposit amount IAₙ of an unsuccessful bidder (i.e., a depositor). The management server of the fund transaction platform calculates the deposit amount IAₙ of the depositor in two manners according to the order of interest payment:

Early interest payment:

(U−IAₙ)×(1+Rₙ)^{N-n}= (12)

Late interest payment:

U×(1+Rₙ)^{N-n}=U+IAₙ (13)

where,

U is a bidding upper limit;

N is total contracted periods;

n is a current period, and n≦N;

IAₙ is the deposit amount of the depositor calculated according to the average borrowing interest rate of the n^{th} period; and

Rₙ is an average borrowing interest rate.

If a bidder wins the bid at this time point, the management server of the fund transaction platform calculates the deposit amount IAₙ according to the average borrowing interest rate. The amount to be deposited by the unsuccessful bidder is similarly calculated based on the following two formulas according to the order of interest payment:

Early interest payment:

U−IAₙ (14)

Late interest payment:

U (15)

where,

U is a bidding upper limit; and

IAₙ is the deposit amount of the depositor calculated according to the average borrowing interest rate of the n^{th} period.

If no bidder wins the bid, but the bidder submits a bid at this time point (a deposit is needed due to the unsuccessful bidding), the management server of the fund transaction platform calculates the deposit amount of the bidder based on the following two formulas according to the order of interest payment:

Early interest payment:

U−IHₙ (16)

Late interest payment:

U (17)

where,

U is a bidding upper limit; and

IHₙ is a highest bidding amount of the bidder who loses the bid in the n^{th} period.

As for the unsuccessful bidder, if no bidder wins the bid and the bidder does not submit any bid in the n^{th} period, the management server of the fund transaction platform calculates the deposit amount of the bidder based on the following two formulas according to the order of interest payment:

Early interest payment:

U−IXₙ (18)

Late interest payment:

U (19)

where,

U is a bidding upper limit; and

IXₙ is the deposit amount of the depositor calculated according to a benchmark interest rate of the n^{th} period.

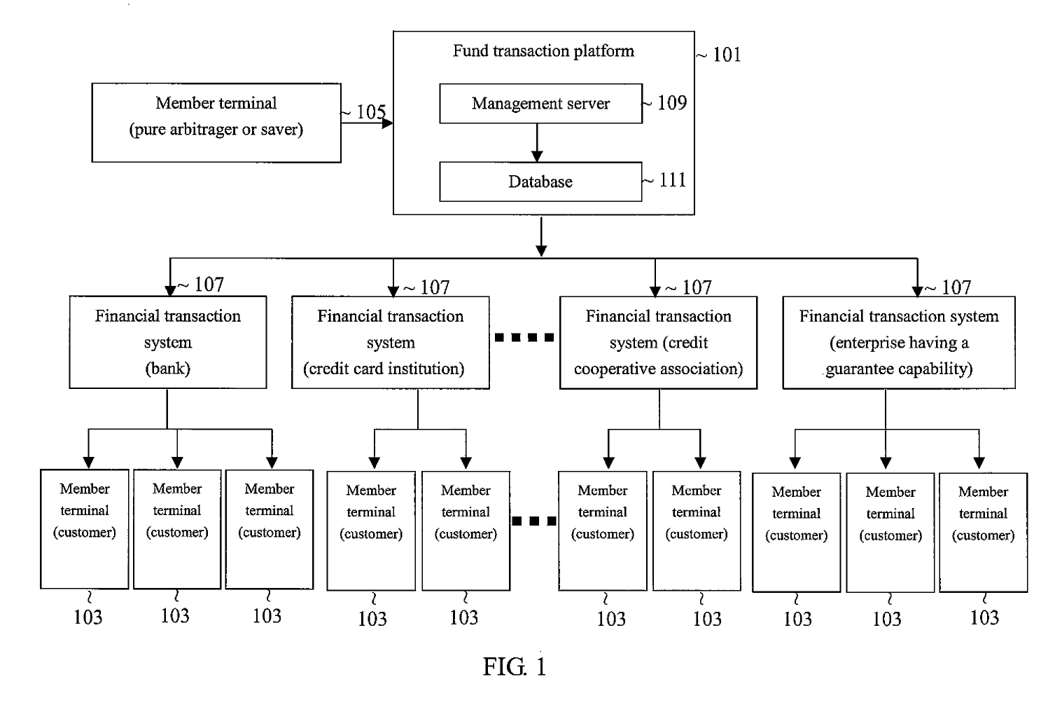

FIG. 1 is a block diagram of a fund transaction platform of autonomous interest rates of a capital pool of the present invention. In FIG. 1, member terminals 103 and 105 are connected to a fund transaction platform 101 via the Internet, a wired communication device, a wireless communication device, a local area network, or the like. A customer of a clearing member registers with the fund transaction platform 101 through the member terminal 103, or a pure arbitrager or saver registers with the fund transaction platform 101 through the member terminal 105, so as to become a bidding or savings member of the fund transaction platform 101, thereby operating various functions of the fund transaction platform 101.

The clearing member is a bank, a credit card institution, a credit cooperative association, or an enterprise having a guarantee capability that has the credit check, credit rating, or credit line determining function or is capable of providing a member with a guarantee limit.

The fund transaction platform 101 establishes an information flow with a financial transaction system 107 of the clearing member via the Internet, a wired communication device, a wireless communication device, a local area network, or the like. A settlement account of the fund transaction platform 101 carries out a remittance of a settlement amount with the clearing member to establish the fund flow of between them.

The fund transaction platform 101 includes a management server 109 and a database 111. When the clearing member applies to join the fund transaction platform 101, the management server 109 checks the applying clearing member according to audit data provided by the clearing member. The fund transaction platform 101 signs a cooperation contract online with the clearing member passing the check of the management server 109. The management server 109 stores the data of the checked clearing member, the check result, and the signed contract in the database 111.

The fund transaction platform 101 exchanges information with the financial transaction system 107 of the clearing member through the information flow. The management server 109 compares and confirms an account number and a password entered by a member holding an electronic bidding card, so that the member passing the security control audit of the management server 109 registers with the platform. The clearing member issues an electronic bidding card to the customer thereof. The customer holding the electronic bidding card enters the account number and password of the electronic bidding card into the fund transaction platform 101 through the member terminal 103, so as to become a member of the fund transaction platform 101. The management server 109 stores the data of the member holding the electronic bidding card in the database 111, and meanwhile stores the corresponding account number and password of the electronic bidding card of the member in the database 111.

The pure arbitrager or saver will not apply for a credit limit, but directly applies to join the fund transaction platform 101 through the member terminal 105, and provides information (for example, personal basic information and credit checking data) about the pure arbitrager or saver to the fund transaction platform 101. The management server 109 audits the data of the applying pure arbitrager or saver. After the audit is passed, the fund transaction platform 101 will issue an electronic bidding card to the pure arbitrager or saver. The pure arbitrager or saver enters an account number and a password of the electronic bidding card thereof through the member terminal 105 to register with the fund transaction platform 101, so that the pure arbitrager or saver becomes a member of the fund transaction platform 101. The management server 109 stores the data of the pure arbitrager or saver holding the electronic bidding card in the database 111, and meanwhile stores the corresponding account number and password of the electronic bidding card of the pure arbitrager or saver in the database 111.

The members qualified for bidding enter a bidding amount into the fund transaction platform 101 through the member terminals 103 and 105. The management server 109 calculates an average deposit interest rate and a borrowing interest rate based on the description on the third step of the deposit and borrowing method of autonomous interest rates according to the bidding amounts of all members. In the first to fourth steps of the deposit and borrowing method of autonomous interest rates, the management server 109 determines a successful bidding amount and a number of successful bidders according to a fund balance of the fund transaction platform 101 and the borrowing interest rates of all bidding members. In the fifth and sixth steps of the deposit and borrowing method of autonomous interest rates, the management server 109 clears a total successful bidding amount of successful bidding members according to the successful bidding amount, and clears a deposit amount of unsuccessful bidding members according to the average borrowing interest rate and a deposit bid bond, a highest bidding amount, or a benchmark interest rate. The management server 109 stores the average deposit interest rate, the borrowing interest rate, the fund balance, the successful bidding amount, the number of the successful bidders, the total successful bidding amount, the deposit bid bond, the average borrowing interest rate, and the deposit amount in the database 111.

The fund transaction platform 101 transfers the cleared successful bidding amount, total successful bidding amount, deposit amount, and/or refunding amount to the financial transaction system 107 of the clearing member through the information flow. The fund transaction platform 101 settles the successful bidding amount, the total successful bidding amount, the deposit amount, and/or the refunding amount of the clearing member through the fund flow. The management server 109 stores the data about the clearance, settlement, and the like between the fund transaction platform 101 and the clearing member in the database 111.

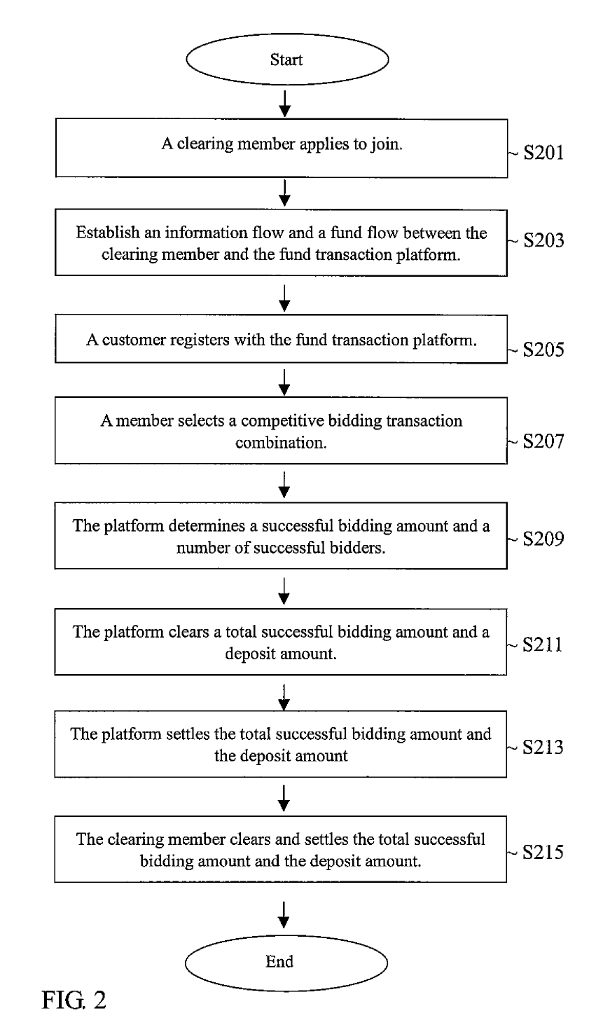

FIG. 2 is a flow chart of a fund transaction method of autonomous interest rates of a capital pool of the present invention. The flow of FIG. 2 is described with reference to the elements in FIG. 1. First, a clearing member, a pure arbitrager, or a saver applies to join the fund transaction platform 101 (Step S201). The clearing member provides data such as corporate assets to the fund transaction platform 101 for checking, while the pure arbitrager or saver provides personal basic information and credit checking data to the fund transaction platform 101 for check.

A fund flow is established between the fund transaction platform 101 and the clearing member, and an information flow is established between the fund transaction platform 101 and the financial transaction system 107 of the clearing member (Step S203). The customer of the clearing member registers with the fund transaction platform 101 through the member terminal 103 to become a member (Step S205).

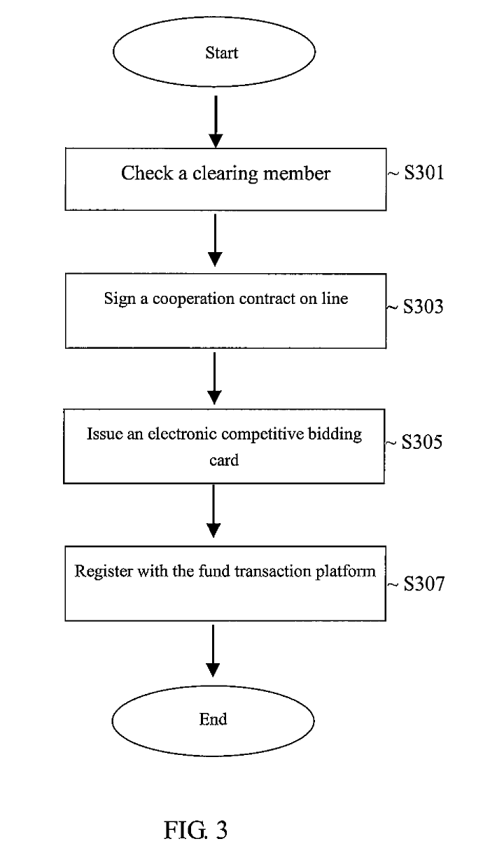

FIG. 3 is a flow chart shows how the clearing member joins in the fund transaction platform in the fund transaction method of autonomous interest rates of the capital pool of the present invention. When the clearing member applies to join the fund transaction platform 101, the management server 109 of the fund transaction platform 101 checks the applying clearing member according to the data provided by the clearing member (Step S301).

Then, the fund transaction platform 101 signs the cooperation contract online with the clearing member passing the check (Step S303). The management server 109 stores the data of the checked clearing member, the check result, and the signed contract in the database 111.

When the customer of the clearing member intends to apply for a fund bidding at autonomous interest rates to the fund transaction platform 101, the clearing member issues an electronic bidding card to the customer thereof (Step S305). The electronic bidding card has a dedicated account number and password. The management server 109 stores the account number and the password of the electronic bidding card of the customer in the database 111.

Afterwards, the customer enters the account number and the password of the electronic bidding card into the fund transaction platform 101 through the member terminal 103 to register with the platform, so that the customer becomes a member of the fund transaction platform 101 (Step S307).

The fund transaction platform 101 exchanges information with the financial transaction system 107 of the clearing member through the information flow. The management server 109 compares and confirms the account number and the password entered by the member holding the electronic bidding card, so that the member passing the security control audit of the management server 109 of the fund transaction platform 101 registers with the platform.

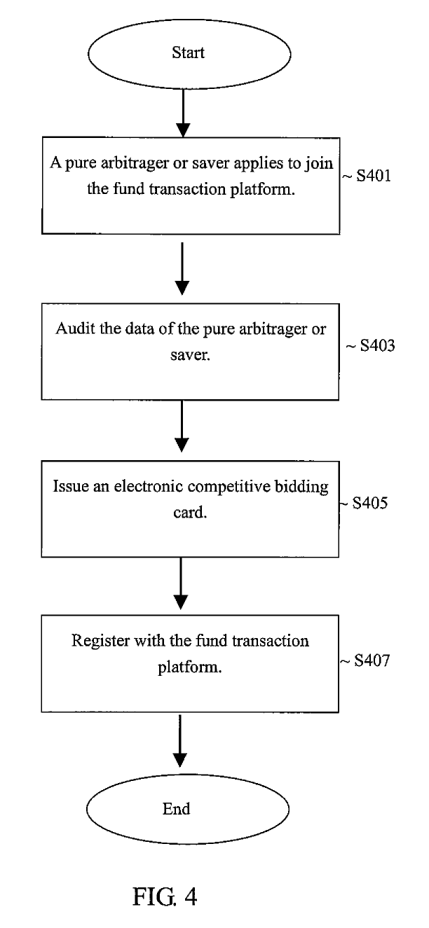

FIG. 4 is a flow chart shows how the pure arbitrager or saver joins in the fund transaction platform in the fund transaction method of autonomous interest rates of the capital pool of the present invention. The pure arbitrager or saver can gain the interest by means of the fund bidding at autonomous interest rates of the fund transaction platform 101. Therefore, the pure arbitrager or saver will not apply for a credit limit, but directly applies to join the fund transaction platform 101 through the member terminal 105 (Step S401).

Then, the management server 109 of the fund transaction platform 101 audits the information (for example, personal basic information) about the applying pure arbitrager or saver (Step S403). After the pure arbitrager or saver passes the audit of the management server 109, the fund transaction platform 101 issues an electronic bidding card to the pure arbitrager or saver (Step S405). The management server 109 stores the data of the checked pure arbitrager or saver and the account number and the password of the electronic bidding card in the database 111.

Afterwards, the pure arbitrager or saver enters the account number and the password of the electronic bidding card through the member terminal 105 to register with the fund transaction platform 101, so that the pure arbitrager or saver becomes a member (Step S407).

Referring to FIG. 2 again, the member selects a bidding transaction combination including a bid bond, a bidding duration, and bidding periods in the fund transaction platform 101 through the member terminal 103 or 105 (Step S207). The management server 109 stores the data of the bidding transaction combination selected by the member in the database 111.

Next, the member enters a bidding amount into the fund transaction platform 101 through the member terminal 103 or 105. The management server 109 calculates an average deposit interest rate and a borrowing interest rate of a bidding member according to the bidding amount entered by the bidding member (such as the third step of the deposit and borrowing method of autonomous interest rates), and determines a successful bidding amount and a number of successful bidders according to a fund balance of the fund transaction platform 101 and the borrowing interest rates (such as the first to fourth steps of the deposit and borrowing method of autonomous interest rates) (Step S209). The management server 109 stores the data of the successful bidding members, the bidding amount, the average deposit interest rate, the borrowing interest rate, the fund balance, the successful bidding amount, and the number of the successful bidders in the database 111.

Then, the management server 109 clears a total successful bidding amount of the successful bidding members according to the successful bidding amount (such as the fifth step of the above deposit and borrowing method of autonomous interest rates), and clears a deposit amount of unsuccessful bidding members according to an average borrowing interest rate and a deposit bid bond of the successful bidding members, a highest bidding amount of the unsuccessful bidding member, or a benchmark interest rate (such as the sixth step of the deposit and borrowing method of autonomous interest rates) (Step S211). The management server 109 stores the data of the total successful bidding amount, the deposit bid bond, the highest bidding amount, and the deposit amount in the database 111.

Afterwards, the fund transaction platform 101 transfers the cleared successful bidding amount, total successful bidding amount, deposit amount, and/or refunding amount of the customer of the clearing member (or the pure arbitrager or saver) to the financial transaction system 107 of the clearing member (or the member terminal 105 of the pure arbitrager or saver) by the information flow. Then, the fund transaction platform 101 settles the successful bidding amount, the total successful bidding amount, the deposit amount, and/or the refunding amount of the customer of the clearing member (or the pure arbitrager or saver) through the fund flow (Step S213). The clearing member clears and settles the successful bidding amount, the total successful bidding amount, the deposit amount, or the refunding amount to the customer (Step S215).

Four embodiments are provided below to illustrate the fund transaction method of autonomous interest rates of the capital pool of the present invention. The embodiments are described with reference to FIGS. 1 to 4.

### EMBODIMENT 1

Assume that Bank A applies to join a fund transaction platform 101 of autonomous interest rates of a capital pool as a clearing member (Step S201). Bank A provides data such as corporate assets for audit to the fund transaction platform 101 for credit checking. Bank A can join in a fund bidding transaction of the online capital pool after the collected credit information is approved.

Afterwards, a fund flow is established between the fund transaction platform 101 and Bank A, and an information flow is established between the fund transaction platform 101 and a financial transaction system 107 of Bank A (Step S203). Customer 1 is a customer of Bank A. Customer 1 intends to join in the fund bidding transaction of the online capital pool, and can register with the fund transaction platform 101 through a member terminal 103 to become Member 1 (Step S205).

When Bank A applies to join the fund transaction platform 101, a management server 109 of the fund transaction platform 101 checks Bank A according to the data provided by Bank A (Step S301).

Then, the fund transaction platform 101 signs a cooperation contract online with Bank A passing the check (Step S303). The management server 109 stores the data of the checked Bank A, the check result, and the signed contract in a database 111.

When Customer 1 of Bank A intends to apply for the fund bidding at autonomous interest rates of the capital pool to the fund transaction platform 101, Bank A issues an electronic bidding card to Customer 1 (Step S305). The electronic bidding card has a dedicated account number and password. The management server 109 stores the account number and the password of the electronic bidding card of Customer 1 in the database 111.

Afterwards, Customer 1 enters the account number and the password of the electronic bidding card into the fund transaction platform 101 through the member terminal 103 to register with the platform, so that Customer 1 becomes Member 1 of the fund transaction platform 101 qualified for the fund bidding at autonomous interest rates of the capital pool (Step S307).

The fund transaction platform 101 exchanges information with the financial transaction system 107 of Bank A through the information flow. The management server 109 compares and confirms the account number and the password entered by Member 1 holding the electronic bidding card, so that the member passing the security control audit of the management server 109 of the fund transaction platform 101 registers with the platform.

For example, Customer 1 is granted a credit limit of 100,000 dollars after the examination of Bank A, and an electronic bidding card exclusively for Customer 1 is issued to Customer 1. Bank A transfers the data of Customer 1 and the electronic bidding card to the fund transaction platform 101 through the information flow.

After obtaining the electronic bidding card, Customer 1 enters the card number and the password of the electronic bidding card into the fund transaction platform 101 through the member terminal 103 to register with the platform, enters the fund transaction platform 101 to become Member 1 qualified for the bidding upon passing the security control audit of the management server 109, and performs various operations in the fund transaction platform 101.

After registering with the fund transaction platform 101, Member 1 can select to perform a data query or select to join in the bidding transaction of the fund transaction platform 101. If Member 1 selects to join in the bidding transaction of the fund transaction platform, the fund transaction platform 101 will ask Member 1 whether to apply for a credit limit. If Member 1 does not apply for the credit limit, Member 1 is a member without a credit limit. In other words, the credit limit that the fund transaction platform 101 gives to Member 1 is zero, so Member 1 belongs to a pure arbitrager or saver. Since no credit limit is needed to raise funds, the initial credit limit of Member 1 can be 0 or a small amount. The credit limit of Member 1 is mainly a naturally generated limit, which increases with the increase of the deposit amount paid in every period plus the gained bid interest.

When Member 1 participates in the bidding transaction of the fund transaction platform 101, the deposit amount paid in every period plus the gained bid interest is converted into the naturally generated limit of Member 1. If the naturally generated limit of Member 1 is greater than or equal to the limit required by the bidding transaction of the fund transaction platform 101, Member 1 can perform the bidding through the bidding transaction procedures of the fund transaction platform 101 to withdraw the fund needed.

Then, Member 1 selects a bidding transaction combination including a bid bond, a bidding duration, and bidding periods in the fund transaction platform 101 through the member terminal 103 (Step S207). The management server 109 stores the data of the bidding transaction combination selected by Member 1 in the database 111.

Next, Member 1 enters a bidding amount into the fund transaction platform 101 through the member terminal 103. The management server 109 calculates an average deposit interest rate and a borrowing interest rate of Member 1 according to the bidding amount entered by Member 1 (such as in the third step of the deposit and borrowing method at autonomous interest rates), determines whether Member 1 or other members can win the bid, and determines a successful bidding amount if the bid is won according to a fund balance of the fund transaction platform 101 and the bid borrowing interest rates of all bidding members (such as the first to fourth steps of the above deposit and borrowing method of autonomous interest rates) (Step S209). The management server 109 stores the data of successful bidding members, the bidding amount, the average deposit interest rate, the borrowing interest rate, the fund balance, the successful bidding amount, and the number of the successful bidders in the database 111.

Then, the management server 109 clears a total successful bidding amount of Member 1 according to the successful bidding amount (such as in the fifth step of the above deposit and borrowing method of autonomous interest rates) if Member 1 wins the bid, or clears a deposit amount of Member 1 according to an average borrowing interest rate and a deposit bid bond of the successful bidding member, a highest bidding amount of Member 1, or a benchmark interest rate if Member 1 does not win the bid (such as in the sixth step of the above deposit and borrowing method of autonomous interest rates) (Step S211). The management server 109 stores the data of the total successful bidding amount, the deposit bid bond, the highest bidding amount, and the deposit amount in the database 111.

Afterwards, the fund transaction platform 101 transfers the cleared successful bidding amount, total successful bidding amount, deposit amount, and/or refunding amount cleared of Customer 1 of Bank A to the financial transaction system 107 of Bank A through the information flow. Then, a settlement account of the fund transaction platform 101 settles the successful bidding amount, the total successful bidding amount, the deposit amount, and/or the refunding amount of Customer 1 of Bank A through the fund flow (Step S213). Bank A clears and settles the successful bidding amount, the total successful bidding amount, the deposit amount, or the refunding amount to a personal account of Customer 1 (Step S215).

### EMBODIMENT 2

Customer 2 of Credit Card Institution B intends to join a fund transaction platform 101 due to the demand for funds. Credit Card Institution B performs Steps S201, S203, S301, and S303 to become a clearing member of the fund transaction platform 101. Customer 2 performs Steps S205, S305, and S307 to become Member 2 of the fund transaction platform 101.

Member 2 enters an account number and a password of an electronic bidding card through a member terminal 103 to register with the fund transaction platform 101. A management server 109 confirms that the account number and the password are correct and permits Member 2 to register with the fund transaction platform 101 after acknowledging the entered account number and password.

Member 2 can select various bidding transaction combinations of a bid bond, a time limit, and a duration pre-combined by the fund transaction platform 101 (Step S207).

For example, Member 2 selects a bidding transaction combination of the bid bond of 10,000 dollars, the bidding duration of 2 years, and the bidding periods of 24 terms. Member 2 enters a bidding amount of 1,000 dollars through the member terminal 103 according to his own financial demand. The management server 109 determines whether Member 2 wins the bid according to the bidding amounts entered by all bidding members as follows:

1. If Member 2 joins in the bidding transaction of the fund transaction platform 101 in the 6^{th} period and the bidding amount entered by Member 2 is 1,000 dollars, the management server 109 determines that Member 2 wins the bid in the current period according to the bidding amounts entered by all the bidding members (Step S209).

The management server 109 clears a total successful bidding amount that Member 2 can gain based on, for example, formula 8 (Step S211):

(10,000 dollars−1,000 dollars)×(24−6)+10,000 dollars×(6−1)=212,000 dollars

Afterwards, the fund transaction platform 101 transfers the total successful bidding amount (212,000 dollars) cleared of Customer 2 (i.e., Member 2) of Credit Card Institution B to a financial transaction system 107 of Credit Card Institution B through the information flow. Then, a settlement account of the fund transaction platform 101 settles the total successful bidding amount of Customer 2 of Credit Card Institution B through the fund flow (Step S213). Next, Credit Card Institution B clears and settles the total successful bidding amount to a personal account of Customer 2 (Step S215).

2. If Member 2 joins in the bidding transaction of the fund transaction platform 101 in the 6^{th} period and the bidding amount entered by Member 2 is 1,000 dollars, the management server 109 determines that Member 2 fails to win the bid in the current period according to the bidding amounts entered by all the bidding members (Step S209). Besides, Member 2 selects not to continue the bidding. Then, Member 2 ends the bidding transaction of the fund transaction platform 101 in the current period.

The management server 109 clears a deposit amount that Member 2 should pay in the current period (the 6^{th} period) according to the bidding amount entered by Member 2 based on, for example, formula 14 (Step S211). That is to say, Member 2 should pay 10,000 dollars−1,000 dollars=9,000 dollars.

Then, the fund transaction platform 101 transfers the cleared deposit amount (9,000 dollars) of Customer 2 (i.e., Member 2) of Credit Card Institution B to the financial transaction system 107 of Credit Card Institution B through the information flow. Then, the settlement account of the fund transaction platform 101 settles the deposit amount of Customer 2 of Credit Card Institution B through the fund flow (Step S213). Credit Card Institution B clears and settles the deposit amount to the personal account of Customer 2 (Step S215).

3. If Member 2 joins in the bidding transaction of the fund transaction platform 101 in the 6^{th} period and the bidding amount entered by Member 2 is 1,000 dollars, the management server 109 determines that Member 2 fails to win the bid in the current period according to the bidding amounts entered by all the bidding members. Besides, Member 2 selects to continue the bidding and enters a bidding amount of 1,200 dollars again. Afterwards, the management server 109 determines that Member 2 wins the bid in the current period according to the bidding amounts entered by all the bidding members (Step S209).

The management server 109 clears a total successful bidding amount that Member 2 can gain based on, for example, formula 8 (Step S211):

(10,000 dollars−1,200 dollars)×(24−6)+10,000 dollars×(6−1)=208,400 dollars

Afterwards, the fund transaction platform 101 transfers the cleared total successful bidding amount (208, 400 dollars) of Customer 2 (i.e., Member 2) of Credit Card Institution B to the financial transaction system 107 of Credit Card Institution B through the information flow. Then, the settlement account of the fund transaction platform 101 settles the total successful bidding amount of Customer 2 of Credit Card Institution B through the fund flow (Step S213). Next, Credit Card Institution B clears and settles the total successful bidding amount to the personal account of Customer 2 (Step S215).

### EMBODIMENT 3

The credit limit is generated from two sources. One source is the credit line of a customer of a clearing member approved by the operator of the fund transaction platform 101. The other source is the limit of the member converted from the amount of a deposit amount paid in every period plus a bid interest gained from the bidding transaction when a pure arbitrager or saver (i.e., not the customer of the clearing member) participates in the bidding transaction of the fund transaction platform 101, which is called a naturally generated limit.

The pure arbitrager or saver can gain interests by means of the bidding at autonomous interest rates of the fund transaction platform 101. Therefore, the pure arbitrager or saver who does not apply for a credit limit directly applies to join the fund transaction platform 101 through the member terminal 105 (Step S401).

Then, a management server 109 of the fund transaction platform 101 audits the information (for example, personal basic information) about the applying pure arbitrager or saver (Step S403). After the pure arbitrager or saver passes the audit of the management server 109, the fund transaction platform 101 issues an electronic bidding card to the pure arbitrager or saver (Step S405). The management server 109 stores the account number and a password of the electronic bidding card thereof of the checked pure arbitrager or saver in the database 111.

Afterwards, the pure arbitrager or saver enters the account number and the password of the electronic bidding card through the member terminal 105 into the fund transaction platform 101 to register with the platform, so that the pure arbitrager or saver becomes Member 3 (Step S407).

For example, Member 3 is a pure arbitrager or saver, and thus needs no credit limit to raise funds. Therefore, an initial credit limit of Member 3 can be 0 dollars. In other words, Member 3 is a saving customer.

Member 3 selects a bidding transaction combination of a bid bond of 10,000 dollars, a bidding duration of 2 years, and bidding periods of 24 terms on the fund transaction system 101 (Step S207). The initial credit limit of Member 3 is 0 dollars, which increases with the increase of the deposit amount paid in every period plus the bid interest of the bidding transaction of Member 3. This is mainly because the deposit amount paid in every period of the bidding transaction of the fund transaction system 101 participated by Member 3 plus the bid interest of the bidding transaction is converted into the credit limit, i.e., the limit naturally generated from the deposit amount paid in every period of Member 3.

When the credit limit of Member 3 accumulates to 240,000 dollars, Member 3 can enter a bidding amount to the fund transaction platform 101 through the bidding transaction procedures of the fund transaction platform 101 and win the bid to withdraw the required funds (Step S209).

Then, if Member 3 wins the bid, the management server 109 clears a total successful bidding amount of Member 3 according to the successful bidding amount (such as in the fifth step of the above deposit and borrowing method of autonomous interest rates) (Step S211). The management server 109 stores the successful bidding amount (i.e., the entered bidding amount) and the total successful bidding amount of Member 3 in the database 111.

Afterwards, the fund transaction platform 101 transfers the cleared total successful bidding amount of Member 3 to the member terminal 105 of Member 2 through an information flow. Then, a settlement account of the fund transaction platform 101 settles the cleared total successful bidding amount of Member 3 to a personal account of Member 3 through a fund flow (Step S213).

### EMBODIMENT 4

The determination of a basic bid bond of the fund transaction platform 101 of autonomous interest rates of a capital pool is a dynamic process. The basic bid bond is based on variables such as the fund supply, the demand for funds, an interest rate level of the platform operator, and the variation of short-term and long-term interest rates, and is determined by a program operation of a management server of the fund transaction platform 101 (such as in the first to fourth steps of the above deposit and borrowing method of autonomous interest rates). Since the variation of a fund flow is a dynamic process, the basic bid bond is determined by the huge inflow amount and outflow amount.

In addition, if a bidding amount entered by a bidding member of the fund transaction platform 101 does not reach the basic bid bond, the bidding member is regarded as a saver (Step S209). A deposit amount of the difference between the basic bid bond and the entered bidding amount must be paid according to the sixth step of the deposit and borrowing method of autonomous interest rates (Steps S211 to S215).

For example, Member 4 selects a bidding transaction combination of a bid bond of 10,000 dollars, a bidding duration of 2 years, and bidding periods of 24 terms on the fund transaction system 101 (Step S207). A bidding amount of 1,000 dollars entered by Member 4 to the fund transaction platform 101 does not meet the basic bid bond stipulated by the fund transaction platform 101. Then, Member 4 fails to win the bid in this bidding transaction (Step S209). Therefore, the deposit amount cleared according to the management server 109 is 10,000 dollars −1,000 dollars=9,000 dollars (Step S211). Afterwards, Steps S213 and S215 are performed, in which Member 4 performs the settlement procedures of the deposit amount.

The platform operator can also set a minimum bidding price for the saver. The bidding bottom price is set by reference of the deposit interest rate. If the saver does not participate in the bid, the saver must pay an amount of the difference between the bidding bond and the competitive minimum bidding price set by the platform operator as the deposit amount.

For example, Member 5 selects a competitive bidding transaction combination of a bid bond of 10,000 dollars, a bidding time limit of 2 years, and bidding periods of 24 terms on the fund transaction system 101 (Step S207). The platform operator sets the bidding bottom price as 800 dollars, and Member 5 is a saver and does not participate in the bidding. After a clearance of the management server 109 (Step S211), the deposit amount that Member 5 should pay is 10,000 dollars −800 dollars=9,200 dollars. Afterwards, Steps S213 and S215 are performed, in which Member 5 performs the settlement procedures of the deposit amount.

It can be seen from the above illustration that, the specific technical content of the fund transaction platform and method of autonomous interest rates of a capital pool of the present invention has the following advantages:

1. A fund transaction platform of an online capital pool is established through the Internet, and the credit checking, credit control, guarantee, and payment services of existing banks or finance-related institutions are linked by means of bidding, so as to enable members of different attributes such as lending or arbitrage to participate in fund bidding combinations across banks and finance-related institutions, and to create great opportunities for the lender and the borrower to meet rapidly and effectively.

2. A capital bidding platform across banks and peripheral financial institutions is established to form a capital pool. The lender can lend the money without risks under the guarantee of the financial institutions. The borrower also guarantees a fulfillment of the debt under the guarantee of the banks. The banks can reduce the deposit liabilities, and gain the commission charge for lending by retaining customer loyalty without spending a lot of money establishing a fund transaction platform, thereby fully exerting the benefit of economy of scale.

3. A totally open and competitive online fund transaction platform is established, so the interest rate reflects the intensity of demand for funds in the market in real time due to the bidding, and the deposit and the borrowing come into the optimal state of direct finance without distance and without any intermediary due to the integration.

4. A capital pool of a financial system is constructed, which is open to participation of various banks and peripheral financial enterprises, and the flow of savings fund is efficiently directed towards the productive purpose (i.e., the investment) by means of bidding.

Although the present invention has been described above with reference to preferred embodiments and illustrative drawings, they should not be regarded as limitations to the present invention. It will be apparent to those skilled in the art that various modifications, omissions, and variations can be made to the form and contents of the embodiments of the present invention without departing from the scope or spirit of the invention. In view of the foregoing, it is intended that the present invention covers modifications, omissions, and variations of this invention provided they fall within the scope of the following claims and their equivalents.

What is claimed is:

1. A fund transaction method of autonomous interest rates of a capital pool, applied in a fund transaction platform, wherein the fund transaction platform comprises a management server and a database, the fund transaction method of autonomous interest rates of the capital pool comprises:
a clearing member applying to join the fund transaction platform;
establishing a fund flow between the fund transaction platform and the clearing member, and establishing an information flow between the fund transaction platform and a financial transaction system of the clearing member;
a customer of the clearing member registering with the fund transaction platform through a member terminal to become a member;
the member entering a bidding amount into the fund transaction platform through the member terminal, wherein the management server calculates an average deposit interest rate and a borrowing interest rate of bidding members according to the entered bidding amount, and determines a successful bidding amount and a number of successful bidders according to a fund balance of the fund transaction platform and the borrowing interest rates of the bidding members;
the management server clearing a total successful bidding amount of a successful bidding member according to the successful bidding amount and clearing a deposit amount of an unsuccessful bidding member according to the average borrowing interest rate and a deposit bid bond of the successful bidding member, a highest bidding amount of the unsuccessful bidding member, or a benchmark interest rate;
the fund transaction platform transferring the cleared successful bidding amount, total successful bidding amount, deposit amount, and/or refunding amount of the customer of the clearing member to the financial transaction system of the clearing member through the information flow;
the fund transaction platform settling the successful bidding amount, the total successful bidding amount, the deposit amount, and/or the refunding amount of the customer of the clearing member through the fund flow; and
the clearing member clearing and settling the successful bidding amount, the total successful bidding amount, the deposit amount, or the refunding amount to the customer.

2. The fund transaction method of autonomous interest rates of a capital pool according to claim 1, wherein the clearing member is a bank, a credit card institution, a credit cooperative association, or an enterprise having a guarantee capability that has a credit check, credit rating, or credit line determining function or is capable of providing a member with a guarantee limit.

3. The fund transaction method of autonomous interest rates of a capital pool according to claim 1, wherein the fund transaction platform establishes the information flow with the financial transaction system of the clearing member through the Internet, a wired communication device, a wireless communication device, or a local area network, a settlement account of the fund transaction platform carries out a remittance of a settlement amount with the clearing member to establish the fund flow of the two, and the member terminal operates the fund transaction platform through the Internet, a wired communication device, a wireless communication device, or a local area network.

4. The fund transaction method of autonomous interest rates of a capital pool according to claim 1, further comprising the member selecting a competitive bidding transaction combination including a bid bond, a bidding duration, and bidding periods on the fund transaction platform through the member terminal.

5. The fund transaction method of autonomous interest rates of a capital pool according to claim 1, wherein the management server accesses data about the clearing member, the member, the average deposit interest rate, the borrowing interest rate, the fund balance, the successful bidding amount, the number of the successful bidders, the total successful bidding amount, the deposit bid bond, the average borrowing interest rate, and the deposit amount from the database.

6. The fund transaction method of autonomous interest rates of a capital pool according to claim 1, wherein
the management server calculates an amount that all unsuccessful bidding members should deposit at a bid opening time point minus a total successful bidding amount of all successful bidding members at this time point;
the management server determines whether the fund balance at a previous bid opening time point plus the fund balance at this bid opening time point is smaller than or equal to zero;
the management server calculates the borrowing interest rate according to the bidding amount of the bidding member and a bid bond of a selected bidding transaction combination, and sorts the borrowing interest rates of all the bidding members; and
the management server determines the successful bidding amount and the number of the successful bidders according to the fund balance and the borrowing interest rates of the bidding members.

7. The fund transaction method of autonomous interest rates of a capital pool according to claim 1, wherein
when the clearing member applies to join the fund transaction platform, the management server of the fund transaction platform checks the applying clearing member and clears a credit limit;
the fund transaction platform signs a cooperation contract online with the clearing member passing the check;
the clearing member issues an electronic bidding card to the customer thereof; and
the customer enters an account number and a password of the electronic bidding card into the fund transaction platform through the member terminal to register with the fund transaction platform, so as to become the member of the fund transaction platform.

8. The fund transaction method of autonomous interest rates of a capital pool according to claim 7, wherein the fund transaction platform exchanges information with the financial transaction system of the clearing member through the information flow, the account number and the password entered by the member holding the electronic bidding card are compared and confirmed, so that the member passing security control audit by the management server of the fund transaction platform registers with the fund transaction platform.

9. The fund transaction method of autonomous interest rates of a capital pool according to claim 1, further comprising:
a pure arbitrager or saver not applying for a credit limit directly applying to join the fund transaction platform through the member terminal;
the management server of the fund transaction platform auditing data of the applying pure arbitrager or saver;
after the audit is passed, the fund transaction platform issuing an electronic bidding card to the pure arbitrager or saver; and
the pure arbitrager or saver entering an account number and a password of the electronic bidding card through the member terminal to register with the fund transaction platform, so that the pure arbitrager or saver becomes a member.

10. A fund transaction platform of autonomous interest rates of a capital pool, comprising:
a management server, for entering a bidding amount to calculate an average deposit interest rate and a borrowing interest rate, determining a successful bidding amount and a number of successful bidders according to a fund balance of the fund transaction platform and the borrowing interest rate, clearing a total successful bidding amount according to the successful bidding amount, and clearing a deposit amount according to the average borrowing interest rate and a deposit bid bond, a highest bidding amount, or a benchmark interest rate; and
a database, wherein the management server accesses data about the clearing member, the member, the average deposit interest rate, the borrowing interest rate, the fund balance, the successful bidding amount, the number of the successful bidders, the total successful bidding amount, the deposit bid bond, the average borrowing interest rate, and the deposit amount from the database,
wherein a fund flow is established between the fund transaction platform and a clearing member, and an information flow is established between the fund transaction platform and a financial transaction system of the clearing member, the fund transaction platform transfers the cleared successful bidding amount, total successful bidding amount, deposit amount, and/or refunding amount to the financial transaction system through the information flow, and the fund transaction platform settles the successful bidding amount, the total successful bidding amount, the deposit amount, and/or the refunding amount of the clearing member through the fund flow.

11. The fund transaction platform according to claim 10, wherein the fund transaction platform accepts a customer of the clearing member registering through a member terminal as a member.

12. The fund transaction platform according to claim 11, wherein the member terminal operates the fund transaction platform through the Internet, a wired communication device, a wireless communication device, or a local area network.

13. The fund transaction platform according to claim 11, wherein a bidding transaction combination including a bid bond, a bidding duration, and a number of bidding periods is selected on the fund transaction platform through the member terminal.

14. The fund transaction platform according to claim 10, wherein when the clearing member applies to join the fund transaction platform, the management server of the fund transaction platform checks the applying clearing member; the fund transaction platform signs a cooperation contract online with the clearing member passing the check; the clearing member issues an electronic bidding card of the customer; and the customer enters an account number and a password of the electronic bidding card into the fund transaction platform through a member terminal to register with the fund transaction platform, so as to become the member of the fund transaction platform.

15. The fund transaction platform according to claim 14, wherein the fund transaction platform exchanges information with the financial transaction system of the clearing member through the information flow, and the account number and the password entered by the member holding the electronic bidding card are compared and confirmed, so that the member passing the security control audit of the management server of the fund transaction platform registers with the fund transaction platform.

16. The fund transaction platform according to claim 10, wherein a pure arbitrager or saver not applying for a credit limit directly applies to join the fund transaction platform through the member terminal; the management server audits data of the applying pure arbitrager or saver; after the audit is passed, the fund transaction platform issues an electronic bidding card to the pure arbitrager or saver; and the pure arbitrager or saver enters an account number and a password of the electronic bidding card through the member terminal to register with the fund transaction platform, so that the pure arbitrager or saver becomes a member.

17. The fund transaction platform according to claim 10, wherein the clearing member clears and settles the successful bidding amount, the total successful bidding amount, the deposit amount, or the refunding amount to the customer thereof.

18. The fund transaction platform according to claim 10, wherein the clearing member is a bank, a credit card institution, a credit cooperative association, or an enterprise having a guarantee capability that has a credit check, credit rating, or credit line determining function or is capable of providing a member with a guarantee limit.

19. The fund transaction platform according to claim 10, wherein the fund transaction platform establishes the information flow with the financial transaction system of the clearing member through the Internet, a wired communication device, a wireless communication device, or a local area network, and a settlement account of the fund transaction platform carries out a remittance of a settlement amount with the clearing member to establish the fund flow of the two.

20. The fund transaction platform according to claim 10, wherein the management server calculates an amount that all unsuccessful bidding members should deposit at a bid opening time point minus a total successful bidding amount of all successful bidding members at this time point; the management server determines whether the fund balance at a previous bid opening time point plus the fund balance at this bid opening time point is smaller than or equal to zero; the management server calculates the borrowing interest rate according to the bidding amount of the bidding member and a bid bond of a selected bidding transaction combination, and sorts the borrowing interest rates of all the bidding members; and the management server determines the successful bidding amount and the number of the successful bidders according to the fund balance and the borrowing interest rates of the bidding members.
